(19) United States
(12) Patent Application Publication
(10) Pub. No.: US 2026/0322228 A1
(43) Pub. Date: Oct. 15, 2026

(54) SYNCHRONOUS MACHINE HAVING A STARTING RESISTOR

(71) Applicant: Innomotics GmbH, 90441 Nürnberg (DE)

(72) Inventors: MATTHIAS CENTNER, Dresden (DE); ERIK KROMPASKY, Nucice (CZ); OLAF REHME, Hamburg (DE)

(73) Assignee: Innomotics GmbH, 90441 Nürnberg (DE)

(21) Appl. No.: 19/116,627

(22) PCT Filed: Sep. 28, 2023
(86) PCT No.: PCT/EP2023/076949

§ 371 Date: Mar. 28, 2025

(30) Foreign Application Priority Data
Sep. 30, 2022 (EP) 22199199.5

(51) Int. Cl. H02K 19/14; H02P 1/02

(52) U.S. Cl. CPC H02K 19/14; H02P 1/027

(57) ABSTRACT

A synchronous machine includes a starting resistor having an electrical conductor which has a specific electrical resistance that is different than a specific electrical resistance of copper.

The invention relates to a synchronous machine with a starting resistor.

When starting synchronous machines, a starting resistor can be used as a component in the short-circuited rotor circuit so that the starting torque advantageously increases. What is known as a “resistance wheel” used for this purpose has a given resistance and a given heat capacity. During the start-up phase and the high current that occurs, this absorbs the amount of heat resulting due to the power loss at the resistor, so the temperature increase at the resistance wheel moves below a limit value determined by the materials used, in particular insulation materials.

It can be problematic, for example, that resistance wheels are designed as rotor components made of copper conductors with a very high overall mass. This circumstance adversely affects both the size and the rotor dynamics of the machine. However, this may be necessary to realize the required heat capacity. The resistance wheel can be made from a large mass of copper conductors to obtain sufficient heat capacity. The copper conductor is arranged in a rotor element in such a way that the required resistance is produced over the cross-section and length of the conductor. For a customary resistance wheel of a large synchronous machine, this can mean a typical mass of, for example, 400 kg.

One object of the invention is to design an improved synchronous machine.

One solution to the problem results from claim 1. Further exemplary embodiments result from the dependent claims 2 to 9.

A synchronous machine has a starting resistor, wherein the starting resistor has an electrical conductor whose specific electrical resistance is different from copper, wherein the starting resistor has, in particular, a hollow structure. The hollow structure can be open or closed. A medium can be located in the hollow structure. Cooling channels or closed volumes can be embodied by means of the hollow structure or hollow structures.

In one embodiment of the synchronous machine, the specific electrical resistance of the electrical conductor is greater than that of copper. The resistance value can therefore be increased by choosing a different material.

In one embodiment of the synchronous machine, the electrical conductor has a lower specific weight than copper. This has the advantage of lower inertia.

In one embodiment of the synchronous machine, the starting resistor has a phase change material. The phase change material can be located in one or a plurality of hollow structure(s). The phase change material can absorb heat energy, in particular in the short term.

In one embodiment of the synchronous machine, the electrical conductor has aluminum or an aluminum alloy. Aluminum is a poorer electrical conductor than copper, but is lighter than copper.

In one embodiment of the synchronous machine, the electrical conductor has a length which exceeds the dimensions of the starting resistor by a multiple. The resistance can thus be further increased.

In one embodiment of the synchronous machine, the electrical conductor is designed as a hollow conductor. The phase change material can be permanently encapsulated inside the hollow conductor.

In one embodiment of the synchronous machine, the electrical conductor is manufactured additively. Complex geometric structures can thus be easily manufactured.

In one embodiment of the synchronous machine, the starting resistor is surrounded by a pot-like element. The phase change material can be accommodated in this pot-like element, which forms a restructuring.

In principle, the starting resistor may also be manufactured from a material that is a poorer conductor of electricity than copper. Using a material with a correspondingly higher specific electrical resistance than copper results in a lower mass requirement for this material. However, In practice the total amount of heat to be dissipated is often so high that the heat capacity of the reduced mass is not sufficient to keep the maximum temperature that occurs at the resistance wheel below a given limit, so a hollow structure is necessary. For example, in a synchronous machine a first material with a higher specific resistance than copper, with its resulting lower mass requirement, is combined with a second material embedded in this material, what is known as a phase change material. Phase change materials, such as paraffins, firstly have a comparatively high heat capacity and, secondly, absorb heat energy during the phase change without the temperature increasing any further. In principle, both the phase change from solid to liquid and liquid to gas are suitable. The phase change material used can be something which has a corresponding phase change temperature above the maximum ambient temperature and below the permissible temperature limit. A suitable material with a higher specific resistance is, for example, an aluminum alloy, which is also suitable in terms of its heat capacity and, as a lightweight material, also benefits the dynamic properties of the rotor.

In one embodiment of the synchronous machine, a special design of the resistance wheel can result, which allows the lightweight material to be arranged as a very long conductor such that the longest possible path for the current flow results.

In one embodiment of the synchronous machine, the conductor is designed as a hollow conductor, in whose interior the phase change material is permanently encapsulated. In order to simultaneously design the resistance wheel as compact as possible, a design is chosen, in particular, in which the hollow conductor takes up as much space as possible within the enveloping structure of the entire resistance wheel. The enveloping structure is, for example, a pot-like element.

The arrangement of a hollow conductor filled with a phase change material has the advantage, in particular compared to an equally conceivable arrangement of the conductor within a vessel filled with phase change material, that a large surface is created which can be advantageously used for effective recooling because the phase change that has taken place must be reversed as quickly as possible in order to enable further start-up processes of the machine.

In one embodiment of the synchronous machine, this results in a rotor component, for example a cylindrical enveloping structure of the entire resistance wheel, in which a single hollow conductor is arranged in a meandering, spiral-shaped or other manner which saves as much space as possible.

From these statements it can be seen that the design described above places high demands on the manufacturing processes to be used. Firstly, a very long hollow conductor is to be manufactured from a material which is sufficiently strong, simultaneously lightweight and highly accurate so that the rotational forces can be absorbed and the rotor dynamics are positively influenced overall. Secondly, the design described above involves a level of complexity which is difficult to implement in terms of manufacturing technology. One option for this is what is known as the additive manufacturing process, in particular laser beam melting, in which a component is manufactured layer by layer by means of a laser beam in a powder bed. This makes it possible to implement a high level of geometric complexity, such as that offered by the hollow structures described, while at the same time being flexible compared to a manufacturing process which requires a lot of equipment. In particular, a special high-strength aluminum alloy can be used for laser beam melting, which meets the mechanical requirements described above particularly well. Additive manufacturing processes are also subject to certain manufacturing constraints. Thus in the laser beam melting process, structures cannot typically be built up horizontally in the powder bed due to the physically necessary removal of the heat energy introduced by the laser. In this respect, an arrangement of the hollow conductor in a predominantly axial direction is advantageous.

The features of the individual claimed or described subject matters can be readily combined with one another. The invention is represented and explained in more detail below using figures as examples. The features shown in the figures can be combined by a person skilled in the art to form new embodiments without departing from the invention. In the drawings:

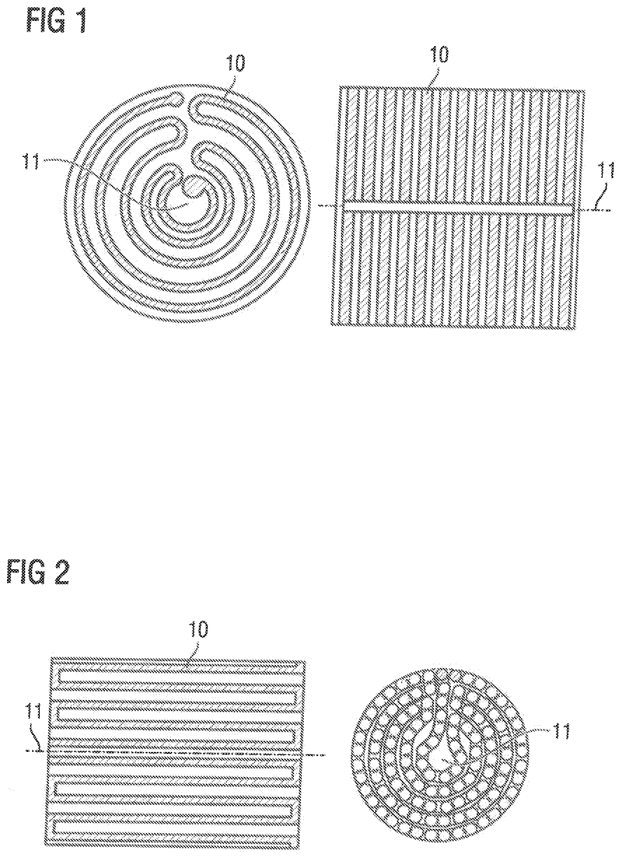

FIG. 1 shows a spiral-shaped arrangement of a hollow conductor,

FIG. 2 shows a meandering arrangement of a hollow conductor,

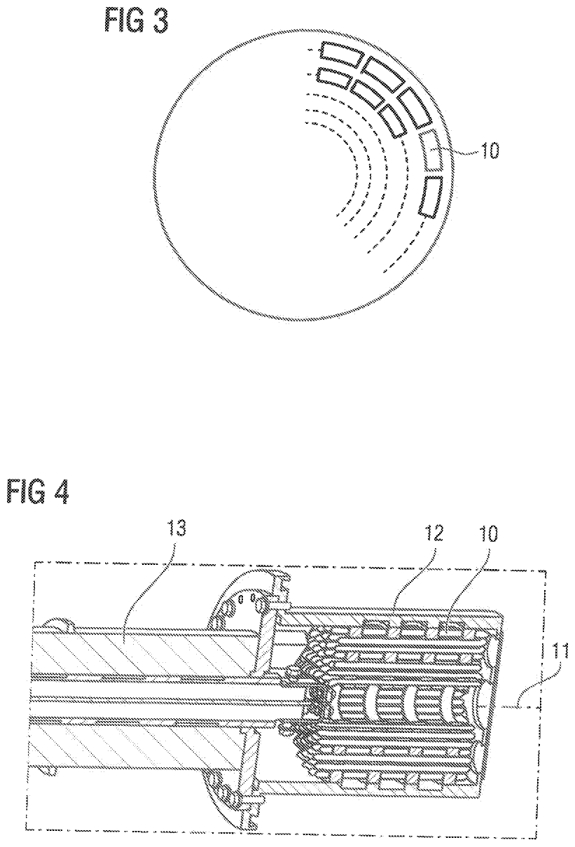

FIG. 3 shows a hollow conductor with an annular sector-shaped cross-section,

FIG. 4 shows a pot-shaped element as a restructuring,

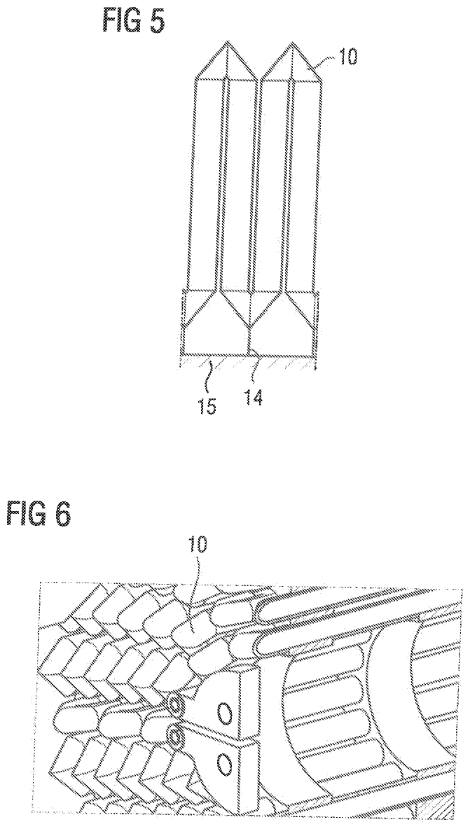

FIG. 5 shows hollow conductor with a minimal support to a construction platform,

FIG. 6 shows an electrical contacting of the hollow conductors,

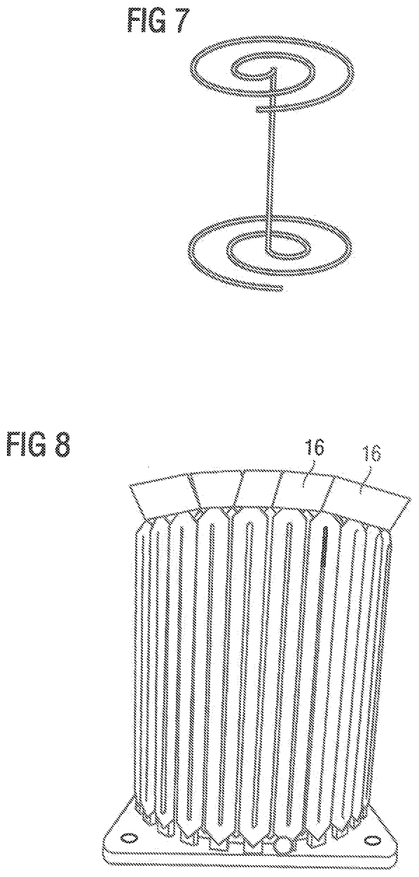

FIG. 7 shows an arrangement of a hollow conductor for improved depowdering,

FIG. 8 shows fan elements for cooling, and

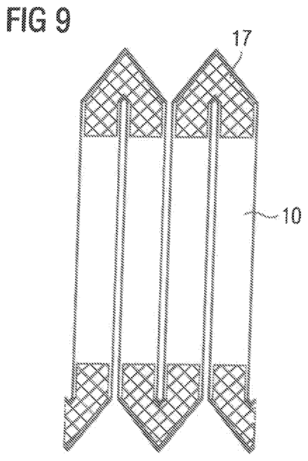

FIG. 9 shows a reinforcement of the hollow conductor by a grid structure and

The representation in FIG. 1 shows a spiral-shaped arrangement of a hollow conductor 10 from two perspectives, in an axial view and a radial view. Axially, in relation to the axis 11, a series of a plurality of meandering disks results. This results in a cylindrical enveloping structure of the entire resistance wheel, in which a single hollow conductor is arranged in a meandering, spiral-shaped or other manner which saves as much space as possible.

The representation in FIG. 2 shows a spiral-shaped arrangement of a hollow conductor 10. The meanders are thus wound around the axis 11.

The representation in FIG. 3 shows a hollow conductor 10 with an annular sector-shaped cross-section. A space-saving design therefore results, for example, also by choosing a cross-section in the form of an annular sector instead of a round cross-section for the hollow conductor, so the gaps between adjacent passages of the hollow conductor are minimal. At the same time, the hollow conductor can be arranged such that the resulting rotor component has the lowest possible imbalance.

The representation in FIG. 4 shows a starting resistor with a pot-like element 12 which is attached to the shaft 13. The start and end points of the hollow conductor 10 are located on one of the two end faces of the cylindrical casing so that current can be fed in and out again in a simple manner. Other arrangements (distribution to both end faces and/or over the circumferential surface) are also possible and are not represented here in the figure.

The representation in FIG. 5 shows a hollow conductor 10 which is to a construction platform 15 via a holder 14 as a minimal support.

The representation in FIG. 6 shows a large number of additively manufactured hollow conductors. An embodiment of the connection of the adjacent passages of the hollow conductor by way of tapering connecting tubes, which allows additive manufacturing while simultaneously requiring minimal support for the component on the underside, is advantageous, and this is also represented in FIG. 5. Furthermore, it can be advantageous that an additively manufactured resistance wheel can be manufactured in one piece as a complexly constructed long hollow conductor at the same time with elements for, for example, a shaft-hub connection, for flanges and for electrical contact.

An additively manufactured resistance wheel is filled, for example, with non-melted powder immediately after its manufacture inside the hollow conductor. Before filling with phase change material, the powder must be completely removed. In a structure which is very meandering and nested, this can signify a lot of effort. In order to ensure that depowdering is as effortless as possible, a design is therefore advantageous which provides a spiral-shaped arrangement of the hollow conductor, in which depowdering can be carried out by simply rotating the overall structure axially. This is represented in FIG. 7. Other designs require complex multi-axis movements to carry out depowdering. A structure according to FIG. 7 demonstrates the simultaneous requirement for good additive manufacturing (for example with the axial direction as the build direction) and good depowdering.

For the purpose of mechanical stabilization of the additively manufactured rotor component, described above, during operation at typical nominal speeds of, for example, 1,800 or 3,600 rpm, this is embedded, for example, in a pot-shaped restructuring and the gaps are filled with an electrically insulating resin (see FIG. 4 in this regard). The resin fulfills the function of insulating individual passages of the hollow conductor as well as insulating it from the pot-shaped restructuring. For example, the structure is only partially filled with resin (for example in segments in the form of disks), so air circulation in the remaining areas allows heat to be dissipated (Drawing 6) in the sense of the above-mentioned effective recooling. The advantage of additive manufacturing of the inventive rotor component is that further complex geometric components can be produced in one manufacturing step.

For example, impeller structures 16, which supply cooling air to the rotating structure for better heat dissipation, as represented in FIG. 8, can also be designed additively.

In order to optimize the actual function of the component (provide electrical resistance), it is of interest to make the cross-section of the hollow conductor as small as possible, but still to make the overall structure of the rotor component as rigid as possible, in particular since it is a long, multiply folded hollow conductor in which neighboring passages cannot support each other. The structure of the rotor component is thus subject to flexibility. In order to limit this, the hollow conductor can be reinforced on the inside, for example by introducing a lattice structure which fills the volume completely or partially. The lattice structure can advantageously counteract torsional moments which occur between the passages, in particular if it is provided in the region where two adjacent passages of the hollow conductor are connected. A lattice structure 17 is represented in FIG. 9.

1.-9. (canceled)

10. A synchronous machine, comprising a starting resistor comprising an electrical conductor which has a specific electrical resistance that is different than a specific electrical resistance of copper.

11. The synchronous machine of claim 10, wherein the starting resistor has a hollow structure.

12. The synchronous machine of claim 10, wherein the specific electrical resistance of the electrical conductor is greater than the specific electrical resistance of copper.

13. The synchronous machine of claim 10, wherein the electrical conductor has a specific weight which is lower than a specific weight of copper.

14. The synchronous machine of claim 10, wherein the starting resistor comprises a phase change material.

15. The synchronous machine of claim 10, wherein the electrical conductor comprises aluminum or an aluminum alloy.

16. The synchronous machine of claim 10, wherein the electrical conductor has a length which exceeds dimensions of the starting resistor by a multiple.

17. The synchronous machine of claim 10, wherein the electrical conductor is designed as a hollow conductor.

18. The synchronous machine of claim 10, wherein the electrical conductor is manufactured additively.

19. The synchronous machine of claim 10, further comprising a pot-like element designed to surround the starting resistor.
